(19) United States
(12) Patent Application Publication
(10) Pub. No.: US 2008/0256556 A1
(43) Pub. Date: Oct. 16, 2008

(54) Method for Controlling the Interface of a Plurality of Types of Radiocommunication Terminals by Defining Abstract Events, Corresponding Computer Programs, Signal and Terminal

(75) Inventors: Jean-Claude Dufourd, Le Kremlin Bicetre (FR); Julien Perron, Rennes (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Streamezzo, Paris (FR)

(21) Appl. No.: 12/066,953

(22) PCT Filed: Sep. 12, 2006
(86) PCT No.: PCT/EP06/66304

§ 371 Date: Jun. 9, 2008

(30) Foreign Application Priority Data
Sep. 14, 2005 (FR) 0509411

(51) Int. Cl. G06F 9/44

(52) U.S. Cl. 719/318

(57) ABSTRACT

A method is provided for controlling the interface of a plurality of types of radiocommunications terminals. The method includes defining a set of abstract events, each of which correspond to a predefined interface-independent generic and functional interaction, such as for a given type of terminal, associating concrete events available and/or executable on the terminal to at least certain abstract events in such a way that it makes it possible to develop an application independently of the interface specificities of each type of terminal and to homogeneously carry out all applications developed with the aid of abstract events on a given terminal.

### CROSS-REFERENCE TO RELATED APPLICATIONS

This Application is a Section 371 National Stage Application of International Application No. PCT/EP2006/066304, filed Sep. 12, 2006 and published as WO 2007/031530 on Mar. 22, 2007, not in English.

### FIELD OF THE DISCLOSURE

The field of the disclosure is that of man-machine interfaces for electronic devices, and especially but not exclusively for portable devices.

More precisely, this disclosure relates to man-machine interfaces of electronic devices or terminals, for example mobile and/or radiocommunication, allowing for the interaction in particular with interactive multimedia content.

### BACKGROUND OF THE DISCLOSURE

1. Known Solutions from Prior Art

Radiocommunication terminals known from prior art allow for interaction with content or multimedia scenes, most often by using a man-machine interface comprising concrete means of interaction, for example a reduced-size alphanumeric keyboard, or a screen having a plurality of interactive zones that can be activated using a stylus.

Current experience today shows that with existing multimedia formats, only concrete events that are in relation with concrete means of interaction are defined, which most often implies the use and management of events associated with keys of a man-machine interface, either physically which is commonly referred to as “hard keys”, or of a software nature which are commonly referred to as “soft keys”.

However, when on a radiocommunication terminal one wishes to favour interactivity between the user and the various functions offered by this terminal, it is desirable that the user, for a terminal of a given type, be able to access different functions always in the same way and not necessarily always through the predefined keys of a keyboard interface.

In attempting to achieve this latter objective, events that can be qualified as abstract have been defined in certain technical solutions known to prior art.

2. Disadvantages of Techniques According to Prior Art

Such abstract events are however defined most often in order to allow for interfacing between the functions or actions of the terminal and events of the multimedia scene that are not directly triggered by user action on the man-machine interface made available to the latter.

Abstract events such as those known today in the prior art are for example of the type:
within the framework of a network protocol implemented by the terminal: the establishment of a connection, the start of downloading data, the end of downloading data, etc.;
within the framework of management by the terminal of the different operating system signals: error detection, missing file detection, low battery level detection, etc.

In addition, among the known descriptive formats or languages such as:
DOM3, for “Document Object Model”;
HTML, for “Hyper Text Markup Language”;
the SVG language, for “Scalable Vector Graphics”;
the SMIL language for “Synchronized Multimedia Integration Language”, whose purpose consists in allowing for the integration of multimedia elements into a Web page;
the XML events module, whose purpose consists in allowing for uniform integration of event listeners and of event managers associated to the event interfaces of a document object model in DOM format;

a common and unique event called “activate” can also be considered as an abstract event, in the sense that different concrete events can be translated in the form of a common event called “activate”.

However, translating concrete events into “activate” is performed either directly by the operating system of the terminal, or by a media player software embedded in the latter, or by a script present in the multimedia scene.

A major disadvantage of this known type of event of the “activate” type is linked to the fact that its translation can vary from one multimedia service to another, or from one content to another.

However, such a disadvantage goes against one of the basics in the use of abstract events in the sense of an embodiment of the present invention, which is consistency from one service to another, from one content to another, with the objective of maintaining perfect ergonomic coherency, especially but not exclusively, between terminals of the same type.

In this sense, the “activate” event defined for the aforementioned formats and languages is therefore not an abstract event in the sense of the invention.

In addition, an additional disadvantage of the “activate” abstract event is linked to the fact that it does not cover the needs for creating multimedia scenes for actions other than the strict activation of multimedia objects.

Moreover, another disadvantage of existing multimedia formats such as those mentioned above, in particular stemming from the work of the “Device Independence” group of W3C (“Device Independence working group page”, http://www.w3.org/2001/di), comes from the fact that they are limited in the creation of scenes independent from a particular device or terminal (and from its means of interaction) to the specification in the multimedia scene of a set of event equivalences. Such a set contains a set of types of known devices or terminals to which are respectively associated a set of equivalences between abstract events and concrete events that are adapted to each type of device or terminal.

As such, for the specification of a multimedia scene that is to be restored on a terminal or a device of a given type, it is necessary to add to the description file of the latter the set of events equivalent to the adapted concrete events that can be taken into account by the terminal.

A disadvantage of this type of technique based on event equivalences relates to the additional cost associated with the taking into account of new devices and/or radiocommunication terminals that each content producer must support.

In addition, adding information in the form of list(s) of equivalences between events in each multimedia scene induces an additional downloading cost for any interactive scene that has to be restored on a terminal, which goes against the objectives of improving interactivity by the content suppliers and terminal manufacturers.

In addition, even though the additional downloading cost induced by taking into account such equivalence lists between predefined abstract events and types of terminals or devices would be small for a given type of terminal, the very high number of types of terminals and devices currently available on the market that allow the multimedia scenes to be restored would make the size of the list prohibitive and almost impossible to use.

### SUMMARY

An aspect of the present disclosure is directed to a method of controlling the interface of a plurality of types of radiocommunication terminals.

According to an embodiment the invention, a set of abstract events (11) is advantageously defined, each one corresponding to a predefined interface-independent generic and functional interaction, such that for a given type of terminal, at least some abstract events (11) are associated to concrete events (16) available and/or which can be executed on the terminal, in such a way as to allow on the one hand the development of an application that is independent of the specificities of each type of terminal and on the other hand that all of the applications developed using abstract events are implemented in a homogenous manner on a given terminal.

An embodiment of the invention thus allows for a new and inventive approach in designing and controlling terminal interfaces, which falls in line with a generic context of simplifying the programming of interactive telecommunications services which also tends to improve the ergonomics of interactions between the user and these services implemented on such terminals, for example mobile telephones.

Indeed, abstract events can now be associated directly with the various input points of the interface or to concrete events that are or are not associated with the latter, according to an optimal choice in terms of ergonomics and ease of navigation in menus and/or interaction with the functions of the terminal.

Preferably, the abstract events (11) belong to the group comprising:
directional events, such as “go up”, “go down”, “go right”, “go left”;
events to validate and/or cancel an operation in progress;
events controlling the beginning and/or ending of a “drag-and-drop” operation;
navigation events, such as “next”, “previous”;
events for controlling a menu.

Advantageously, the concrete events (16) belong to the group comprising:
keystrokes of the keys of a keyboard;
actions on a wheel, stick or ball;
presses on graphics buttons defined on a screen;
vocal commands,

Preferably, in a given terminal, the following steps are implemented:
triggering a concrete event (16);
interpretation (12) of said concrete event (16), associating (15) it to an equivalent abstract event (11);
execution (13) of a physical action (14) associated to said abstract event (11).

As such, when the user interacts with his terminal, he generates a concrete event that the media player embedded in the terminal will detect in the scene (normal case of processing for concrete events) before checking to see if this concrete event has an associated abstract event; if this is the case, it translates the concrete event into an equivalent abstract event and the physical action associated with the abstract event is executed in the scene.

Preferably, abstract events are defined in the terminal or media player.

an embodiment of the invention also relates to a computer software product downloadable from a communications network and/or stored on a computer-readable support and/or which can be executed by a microprocessor.

According to an embodiment of the invention, such a computer software product includes programming code instructions to implement the aforementioned method of controlling the interface.

An embodiment of the invention also relates to a computer software product downloadable from a communications network and/or stored on a computer-readable support and/or which can be executed by a microprocessor, comprising advantageously programming code instructions for implementing an application for radiocommunication terminal, the application implementing a set of abstract events, each corresponding to a predefined generic and functional interaction, and with at least some of the abstract events being associated to concrete events available and/or which can be executed on the terminal.

An embodiment of the invention also relates to a data support carrying at least one application for radiocommunication terminal, the application implementing, advantageously, a set of abstract events, each corresponding to a predefined generic and functional interaction, with at least some of the abstract events being associated with concrete events that are available and/or which can be executed on the terminal.

An embodiment of the invention also advantageously relates to a data signal representative of an application for radiocommunication terminal and comprising data representative of abstract data each corresponding to a predefined generic and functional interaction, with at least some abstract events being associated with concrete events that are available and/or which can be executed on the terminal.

An embodiment of the invention finally relates to a radiocommunication terminal comprising Preferably means of implementing of a set of abstract events, each corresponding to a predefined generic and functional interaction, with the abstract events being associated with concrete events that are available and/or which can be executed on said terminal.

According to such a terminal, the means of implementing a set of abstract events includes Preferably:
means of reading data that is representative of at least one of the concrete events (16);
means for interpreting said at least one concrete event, associating it with a corresponding abstract event;
means of executing a physical action associated with the abstract event.

### BRIEF DESCRIPTION OF THE DRAWINGS

Other characteristics and advantages shall appear more clearly when reading the following description of a preferred embodiment, provided by way of a simple illustrative and non-limiting example, and the annexed drawings, among which:
FIG. 1 shows a flow chart of the major steps in the method of controlling the interface according to an embodiment of the invention;
FIG. 2 shows an example of associating identical abstract events with interfaces of two terminals of different types.

### DETAILED DESCRIPTION OF ILLUSTRATIVE EMBODIMENTS

An embodiment of the invention therefore relates to a technique for controlling the interfaces of terminals of different types, for example and not exclusively radiocommunication, using the implementation of so-called abstract events, each corresponding to a predefined generic and functional interaction independent of each one of the man-machine interfaces proposed by these various terminals.

An embodiment of the invention finds an especial particular interest in the framework of a generic approach in the designing of mobile telecommunication services and/or applications Indeed, abstract events are not associated to a type of interface of a terminal of a given type, but are now programmed and/or defined directly by the designer or author of the telecommunication service and/or of the application in a manner that is fully independent of the interface and of the terminal.

It then falls to the terminal ergonomist that must execute the service and/or application the relatively simple task of making the connection, in the most optimal and ergonomic manner possible, between the abstract events and the input interface of the terminal under consideration: buttons, wheels, soft keys, etc. This is further made simpler in that the prior definition of the various abstract events has been carried out in a manner that is perfectly independent of the services or terminal embedding these services, for example in consideration of one or several service classes: mobile services, services for PC, services for personal digital assistant (or PDA), etc.

As such, and in a more precise manner, it is sufficient for the manufacturer who decides to equip a device or a radiocommunication terminal with a set of means for interaction, to optimally associate the predefined abstract events, for example “go back”, to a particular means of the interface available on the device or terminal, for example a hard button on the side of the device, or to a soft key.

Then, when the author or designer of interactive services wants to refer to a current interactive form, such as for example a go back, he defines as a source of interaction the existing abstract event “go back”.

The user, regardless of the service that is using the abstract events that are implemented as such by the manufacturer, shall have a coherent and ergonomic interface on his device.

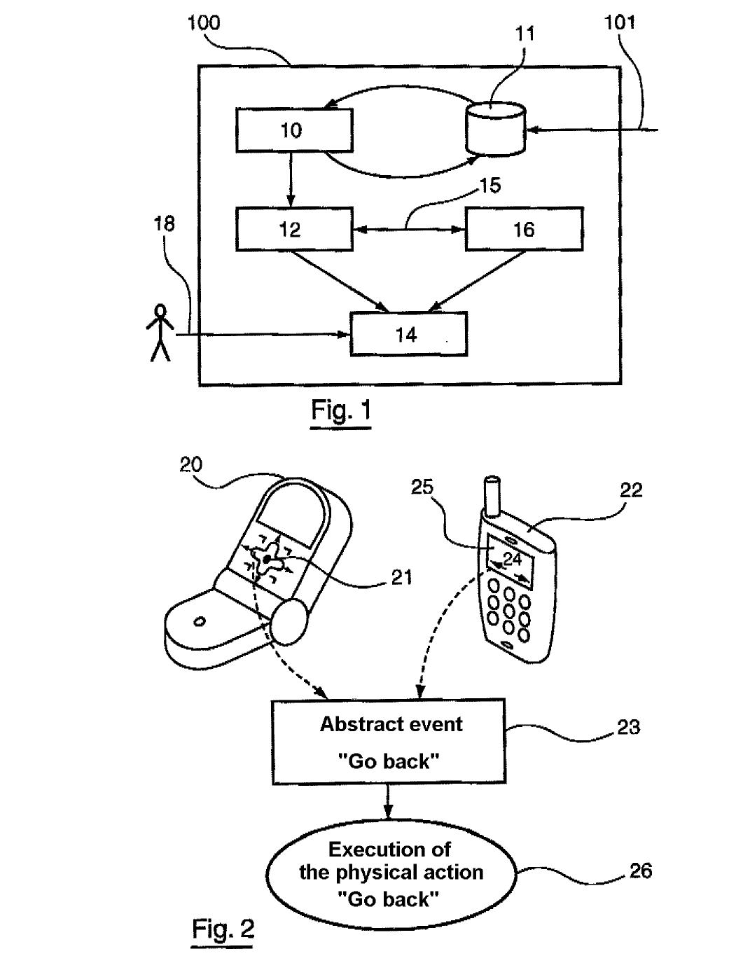

For example and as shown in FIG. 2 a first manufacturer can decide that all of the abstract events 23 of the “go back” type shall be associated for a given terminal 20 or device, to a press towards the left of central navigation wheel 21 of the device or terminal, while for a second manufacturer, these abstract events of the “go back” type shall be associated for another given terminal 22 or another device, to a specific go back graphics button 24 available on the lower right of screen 25.

The interpretation by terminal 20 or 22 of abstract event 23 associated respectively to a press towards the left of wheel 21 or to a press on screen button 24 shall result in the execution on terminal 20, 22, of the corresponding go back physical action 26 from the current state of a multimedia scene.

The technique according to an embodiment of the invention is therefore centred on the concept and the implementation of abstract events for controlling man-machine interfaces of devices or of terminals, for example of radiocommunication.

An abstract event has in particular clear semantics and is commonly used in the multimedia services under consideration, not directly linked to a particular concrete event.

It is intended to be used in a description of a multimedia scene instead of and to stand for a concrete event (a press of a special key for example and proper to a given terminal only).

Indeed, and as shown below through an example of computer code, the description according to prior art for a new scene usually implements predefined concrete keyboard events of the “accessKey” type, in order to allow a user of a terminal, for example a mobile telephone, to interact with at least some of the features made available to him by the latter.

<!-Beginning of the description of the new scene according to prior art-->
< lsr:NewScene>
<svg width= “176” height” “208”>
<g lsr:scale=“1 −1” Isr:translation=“88 104”>
<g>
[...]

<!--Definition of an interactive link of the “confirm” type directly with the predefined hard key “fire” of the targeted terminal and implementation of an object listening for solicitations of the confirm key in order to trigger when necessary the concrete action of confirmation requested by the user, the latter being defined in the form of an associated script-->

< ev:listener event= “accessKey(FIRE)” handler= “#Co”/>
<script id=“co”> <!-Beginning of script associated with
the “confirm” key -->
<lsr: Replace ref=“flag” attributeName= “color.fill”
value = “rgb(0,0,255)”/>
</script> <!--End of script associated with the “confirm” key -- >
[...]

<!--Definition of an interactive link of the “previous page” type directly with the predefined physical key “go up” of the targeted terminal and implementation of an object listening to the solicitations of this key in order to trigger, when necessary, the concrete action aiming to go up, for example to a previous page defined in the scene, which is defined in the form of an associated script-->

<ev:listener event=“accessKey(UP)” handler=“#N 1003 C”/>
<script type=“text/laserScript” id=“NI 003C”>
<!-beginning of script associated with the “go up” key -- >
<lsr:Add attributeName=“translation” ref=“tr” value=“0 5”/>
</script><!-end of script associated with the “go up” key -- >
[...]
</g>
</g>
</svg>
</lsr.NewScene> <!-End of the scene description according to prior art-->

As such, the reader shall easily understand when reading the preceding example that the designer of a scene must necessarily provide in advance at what input point of the physical interface (keyboard for example) of a given terminal he must associate the execution of a concrete event.

On the contrary, the technique according to an embodiment of the invention makes it possible advantageously to make the designing of a scene fully independent from the interface and the interactive capacities of a given terminal (especially concerning the hard keys on the latter). Another advantage of the technique according to an embodiment of the invention, as shown through the example of a description of a new scene below, relates to the simplicity of implementing it, not only at the time of designing the scene since it is sufficient for the designer to replace in the descriptive file of the scene the name of the concrete event that is usually provided according to the techniques of prior art, with the name of the abstract event to be triggered, but at the moment as well when the scene is implanted on the terminal, since it is then sufficient for the manufacturer of the latter to provide the name or identifier of the interactive object available on the terminal and to which he wishes to associate an abstract event called in the scene.

As such, it becomes possible in a very simple way, using the technique according to an embodiment of the invention, to associate the same abstract event to different interactive objects of a terminal, whether these objects take the form of hard buttons or wheels, or in the form of graphics elements, on the terminal.

By way of illustrative example, the aforementioned description file, present in relation with the techniques known in prior art now takes on the following form when the technique according to an embodiment of the invention is implemented

```
  < !--Beginning of the description of the new scene according
to an embodiment of the invention-->
  <lsr: NewScene>
  <svg width=“176” height=“208”>
  <g lsr:scale=“1 −1” lsr:translation=“88 104”>
  <g> [...]
```

<!-Assigning of the abstract event “confirm” to an interactive object of identifier “#co” and available on the targeted terminal, in such a way that when an interaction with the interactive object “#co” is detected on the terminal, the script <script id=“co”> corresponding to the physical action associated with the abstract event “abstractOK” is executed. -->

<ev:listener event=“abstractOK” handler=“#co”/>
<script id= “co”>
<lsr:Replace ref= “flag” attributeName= “color.fill”
value = “rgb(0,0,255)”/>
</script>
[...]

<!-Assigning of the abstract event “go up” to an interactive object of identifier “#N1003C” and available on the targeted terminal, in such a way that when an interaction with the interactive object “#N1003C” is detected on the terminal, the script <script type=“text/laserScript” id=“N1003C”> corresponding to the physical action associated with the abstract event “abstractUP” is executed-->

```
  <ev:listener event=“abstractUP” handler=“#N1003C”/>
  <script type= “text/laserScript” id= “N1003C”>
  <lsr:Add attributeName=“translation” ref=“tr” value=“0 5”/>
  </script>
  [...]
  </g>
  </g>
  </svg>
  </lsr:NewScene> <!-End of the scene description according
to an embodiment of the invention-->
```

The abstract events can therefore easily be associated by the manufacturer of the multimedia device or of the player or of the terminal to one or several concrete events (the press of a key, for example).

This association is constant, independent of the content or service consulted. As such, when a user interacts with an input element of the user interface of his device, multimedia terminal or radiocommunication terminal, the abstract event associated with this input element is triggered, as well as all of the hard or soft concrete behaviours which are linked to the latter.

A concrete event is an event that is directly linked to a particular interactive means, such as a mouse click.

Abstract events are defined in the scene description format, encoded and transmitted to the device, decoded and composed in the multimedia scene, as concrete events.

The association between concrete events(s) and abstract event is accomplished in each device or terminal optimally, and is not specified in the scene description format.

An example of abstract events that covers the common needs for interaction between a terminal and its user is presented below:
“go up/down/right/left” (possibly diagonally) events making it possible to abstract the choice of the method of directional navigation;
a validation event (ok), making it possible to abstract the origin of the validation (key, joystick, jogdial, vocal entry);
a cancel event, to stop the action in progress;
“start/stop drag-and-drop” events, making it possible to emulate pointing devices that are absent from most mobile devices;
“next/previous” events in order to abstract navigation in a situation when consulting a long text, or in a situation of navigating in a site;
a “menu” event.

These abstract events also make it possible to unify the processing of different interactive methods such as the keys on a keyboard, the graphics buttons on the screen and joystick or wheel devices.

These are defined in the scene description format, encoded and transmitted to the device, decoded and composed in the multimedia scene, as concrete events.

The implantation of the media player already contains a (concrete) event list: a list of abstract events is added to this event list.

As such, a table of association between concrete events and abstract events is added.

An additional listening mechanism for all of the concrete events is also added in such a way that for each concrete event, the player checks if this concrete event is present in the table of association and if this is the case, then triggers the corresponding abstract event.

The association between concrete event(s) and abstract event is accomplished in each device or terminal optimally, and is not specified in the scene description format.

In an example of practical application, for a mobile with wheel, joystick, standard keyboard and no stylus, the events above would be defined by the supplier of the media player software;
go up would be linked to joystick north;
go down would be linked to joystick south;
go left would be linked to joystick west;
go right would be linked to joystick east;
validation would be linked to pressing the centre of the joystick;
next/previous would be linked to movement of the wheel;
drag-and-drop would be linked to the * and # keys.

In another application example, for a mobile with three lateral buttons and a standard keyboard, the events above would be defined by the supplier of the media player software:
go up would be linked to the 2 key;
go down would be linked to the 8 key;
go left would be linked to the 4 key;
go right would be linked to the 6 key;
validation would be linked to pressing on the central lateral button;
next/previous would be linked to pressing the upper and lower lateral buttons;
drag-and-drop would be linked to the * and # keys.

In any case, the same content would function in a coherent way on each terminal, without the author having to modify/adapt them.

An embodiment of the present invention provides a technique for controlling the interface of a plurality of types of terminals that would allow creators or authors of multimedia scenes to create and manage a set of events that can occur on different terminals, for example subsequent to a user action on his terminal, independently of the various means of interaction available on each one of the terminals on which the multimedia scenes must be able to be restored.

An embodiment of the invention provides such a technique for controlling the interface of a plurality of types of radiocommunication terminals that favour, for a given device, perfect ergonomic coherency of the means of interaction used for each current action, regardless of the service accessed, regardless of the origin and the designer of the service.

An embodiment of the invention provides such a technique that can be used in a large number of embedded applications, for example on radiocommunication terminals, which require a representation of signals that compose it in the form of a spatio-temporal arrangement of graphic objects with which a user must be in a position to interact.

An embodiment of the invention provides such a technique for designing and controlling the interface of a plurality of types of terminals that allow on the one hand the creation of a set of abstract events covering all of the needs of content authors or creators and not only the abstraction of the activation of multimedia objects and, on the other hand the verification in the authoring tools of the independence of the scenes created in this way by the simple examination of the events that they use. In other words, if an author uses only abstract events in a multimedia scene, then the latter will be able to be made fully independent of the means of interaction available on the device or terminal.

An embodiment of the invention provides such a technique that is generic, on the one hand in that it can be applied to practically all of the current descriptions of graphics animations: MPEG-4/BIFS, SVG, SMIL, XHTML, etc., while still remaining simple to implement and use, and not costly.

An embodiment of the invention allows a manufacturer of a new terminal or a designer of media player software ported to this new terminal, in a relatively simple manner, to implement and/or to take into account the correspondence between abstract events and concrete events that are specific to the new terminal, with no need to adapt the applications to the interface of each type of terminal that has to embed them.

Although the present disclosure has been described with reference to one or more examples, workers skilled in the art will recognize that changes may be made in form and detail without departing from the scope of the disclosure and/or the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. Method of restoring a multimedia scene on a radiocommunication terminal, comprising the following steps:
reception of a description file of said scene, comprising first events allowing a user to interact with said scene;
restitution of said scene, comprising a step of managing second events generated by a user using a man-machine interface,
wherein said first events are abstract events, introduced into said description file by an author, and each corresponding to a predefined interface-independent generic and functional interaction, and comprising at least one of the events belonging to the group comprising:
directional events, such as “go up”, “go down”, “go right”, “go left”;
validation and/or cancelling of events for an operation in progress;
control events for the starting and/or ending of a “drag-and-drop” operation;
navigation events, such as “next”, “previous”;
events for controlling a menu;
and wherein said second events are concrete events of the interface of said terminal, belonging to the group comprising at least:
keystrokes of keys of a keyboard;
actions on a wheel, stick or ball;
presses on graphics buttons defined on a screen;
vocal commands,
said terminal containing association data for one or several concrete events to each of said abstract events, defined by the manufacturer of said terminal.

13. Method for restoring a multimedia scene set forth in claim 12, wherein, in a given terminal, the following steps are implemented:
triggering of a concrete event;
interpretation of said concrete event, associating the concrete event to an equivalent abstract event;
execution of a physical action associated to said abstract event.

14. Computer software product stored on a computer-readable support and which can be executed by a microprocessor, wherein the product comprises programming code instructions to implement a method of restoring a multimedia scene on a radiocommunication terminal, comprising the following steps:
reception of a description file of said scene, comprising first events allowing a user to interact with said scene;
restitution of said scene, comprising a step of managing second events generated by a user using a man-machine interface,
wherein said first events are abstract events, introduced into said description file by an author, and each corresponding to a predefined interface-independent generic and functional interaction, and comprising at least one of the events belonging to the group comprising:
directional events, such as “go up”, “go down”, “go right”, “go left”;
validation and/or cancelling of events for an operation in progress;
control events for the starting and/or ending of a “drag-and-drop” operation;
navigation events, such as “next”, “previous”;
events for controlling a menu;
and wherein said second events are concrete events of the interface of said terminal, belonging to the group comprising at least:
keystrokes of keys of a keyboard;
actions on a wheel, stick or ball;
presses on graphics buttons defined on a screen;
vocal commands,
said terminal containing association data for one or several concrete events to each of said abstract events, defined by the manufacturer of said terminal.

15. Computer software product stored on a computer-readable support and which can be executed by a microprocessor, wherein the product comprises programming code instructions to implement an application for radiocommunication terminal, said application implementing first abstract events introduced into said description file by an author, and each corresponding to a predefined interface-independent generic and functional interaction, and comprising at least one of the events belonging to the group comprising:
directional events, such as “go up”, “go down”, “go right”, “go left”;
validation and/or cancelling events for an operation in progress;
control events for the starting and/or ending of a “drag-and-drop” operation;
navigation events, such as “next”, “previous”;
events for controlling a menu;
and second concrete events of the interface of said terminal belonging to the group comprising at least:
keystrokes of keys of a keyboard;
actions on a wheel, stick or ball;
presses on graphics buttons defined on a screen;
vocal commands,
said terminal containing association data for one or several concrete events to each of said abstract events, defined by the manufacturer of said terminal.

16. Data support carrying at least one application for radiocommunication terminal, wherein said application implements first abstract events introduced into said description file by an author, and each corresponding to a predefined interface-independent generic and functional interaction, and comprising at least one of the events belonging to the group comprising:
directional events, such as “go up”, “go down”, “go right”, “go left”;
validation and/or cancelling events for an operation in progress;
control events for the starting and/or ending of a “drag-and-drop” operation;
navigation events, such as “next”, “previous”;
events for controlling a menu;
and second concrete events of the interface of said terminal belonging to the group comprising at least:
keystrokes of keys of a keyboard;
actions on a wheel, stick or ball;
presses on graphics buttons defined on a screen;
vocal commands,
said terminal containing association data for one or several concrete events to each of said abstract events, defined by the manufacturer of said terminal.

17. Data signal representative of an application for radiocommunication terminal, wherein the data signal comprises data representative of first abstract events introduced into said description file by an author, and each corresponding to a predefined interface-independent generic and functional interaction, and comprising at least one of the events belonging to the group comprising:
directional events, such as “go up”, “go down”, “go right”, “go left”;
validation and/or cancelling events for an operation in progress;
control events for the starting and/or ending of a “drag-and-drop” operation;
navigation events, such as “next”, “previous”;
events for controlling a menu;
and data representative of second concrete events of the interface of said terminal belonging to the group comprising at least:
keystrokes of keys of a keyboard;
actions on a wheel, stick or ball;
presses on graphics buttons defined on a screen;
vocal commands,
said terminal containing association data for one or several concrete events to each of said abstract events, defined by the manufacturer of said terminal.

18. Radiocommunication terminal comprising:
means of receiving a description file of a multimedia scene, comprising first events allowing a user to interact with said scene;
means for restoring said scene, comprising means of managing second events generated by a user using a man-machine interface,
wherein said first events are abstract events, introduced into said description file by an author, and each corresponding to a predefined interface-independent generic and functional interaction, and comprising at least one of the events belonging to the group comprising:
directional events, such as “go up”, “go down”, “go right”, “go left”;
validation and/or cancelling events for an operation in progress;
control events for the starting and/or ending of a “drag-and-drop” operation;
navigation events, such as “next”, “previous”;
events for controlling a menu;
and wherein said second events are concrete events of the interface of said terminal, belonging to the group comprising at least:
keystrokes of keys of a keyboard;
actions on a wheel, stick or ball;
presses on graphics buttons defined on a screen;
vocal commands,
and in that said terminal includes means of associating one or several concrete events to each of said abstract events, defined by the manufacturer of said terminal.

19. Radiocommunication terminal set forth in claim 18, wherein the terminal includes:
means for reading data representative of a concrete event;
means of interpreting said at least one concrete event, associating the concrete event to at least one corresponding abstract event;
means of executing a physical action associated to said abstract event.
